(19) United States
(12) Patent Application Publication
(10) Pub. No.: US 2009/0143991 A1
(43) Pub. Date: Jun. 4, 2009

(54) MEASUREMENTS IN A FLUID-CONTAINING EARTH BOREHOLE HAVING A MUDCAKE

(75) Inventor: Charles Flaum, Beijing (CN)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: SCHLUMBERGER TECHNOLOGY CORPORATION, Cambridge, MA (US)

(21) Appl. No.: 11/948,395

(22) Filed: Nov. 30, 2007

(51) Int. Cl. G01N 15/08; E21B 47/06

(52) U.S. Cl. 702/12; 73/152.51

(57) ABSTRACT

A method for determining true formation pressure in formations surrounding a fluid-containing borehole having a mudcake on the surface thereof, including the following steps: at a particular location in the borehole, monitoring the electrokinetic potential across the mudcake; modifying the borehole pressure at the particular location in the borehole; and determining the true formation pressure in the formations surrounding the particular location as being the borehole pressure at which the electrokinetic potential is substantially zero.

### RELATED APPLICATION

The subject matter of this application is related to subject matter of co-pending U.S. patent application Ser. No. 11/947,873, Filed Nov. 30, 2007, of C. Flaum (Attorney Docket No.: 60.1522 US NP), assigned to the same assignee as the present application.

### BACKGROUND OF THE INVENTION

1. Field of the Invention

This invention generally relates to the field of measuring in fluid-containing earth boreholes having a mudcake and, more particularly, to the determination of a property of the mudcake and also to the determination of true formation pressure of formations surrounding the borehole.

2. Description of the Related Art

Existing well logging devices can provide useful information about hydraulic properties of formations, such as pressures and fluid flow rates, and can obtain formation fluid samples for uphole analysis. Reference can be made, for example, to U.S. Pat. Nos. 3,934,468 and 4,860,581. In a logging device of this general type, a setting arm or setting pistons can be used to controllably urge the body of the logging device against a side of the borehole at a selected depth. The side of the device that is urged against the borehole wall includes a packer which surrounds a probe. As the setting arm extends, the probe is inserted into the formation, and the packer then sets the probe in position and forms a seal around the probe, whereupon formation pressure can be measured and fluids can be withdrawn from the formation. The probe typically penetrates the mudcake and communicates with the formation adjacent the mudcake by abutting or slightly penetrating the formations. The pressure measured with the probe at the formation adjacent to the mudcake is sometimes called the “probe pressure” and it can be used as an indicator of the virgin formation pressure, it being understood that there will often be substantial invasion of the formations near the probe. However, the measurement of true formation pressure, especially in relatively low permeability formations, is sometimes rendered difficult or impossible by a phenomenon called “supercharging”.

According to one theory, supercharging is caused by the fact that the permeability of mudcake is not exactly zero, but has some small finite value. In low permeability formations, the resistance to fluid flow due to the mudcake can be of the same order of magnitude as the resistance of the formation to accepting the fluid. Thus, a standard wireline pressure measurement, which measures the pressure difference across the mudcake, will not be sufficient to measure the pressure of virgin formation, since there remains (due to the constant fluid flow across the mudcake), a residual finite pressure difference between the formation at the mudcake interface and virgin formation far away.

As described in applicant's U.S. Pat. No. 5,798,669, an explanation of supercharging can be made by analogy to electrical current flow, since Darcy's law and Ohm's law have the same algebraic form. In this regard, reference can be made, for example, to the diagram of FIG. 1 of the '669 patent. As further described in the '669 patent, instead of making a single probe pressure measurement at a point in the well, the well hydrostatic pressure can be used as the driving potential, and additional probe pressure measurements can be made with different driving potentials. From two such measurements, when the difference in the driving pressures is of the same order of magnitude as the difference between the driving pressure and the formation pressure, the formation pressure can be determined. The technique can be extended to several measurements, to improve the precision of the result.

The above-described technique of the '669 patent is one of the existing methods for determining formation pressure. Measurement of formation pressure is very important in formation evaluation. It can be used, for example, for evaluation of the depletion state of a reservoir, reservoir continuity, and to identify fluids and fluid contacts.

As above indicated, operation of a formation sampling tool, of the type disclosed in the referenced U.S. Pat. Nos. 3,934,468 and 4,860,581, and which, inter alia, measures formation pressure, involves stopping the tool, setting a packer pad, setting a probe, cleaning the probe, extracting a certain volume of formation fluid into the tool, and monitoring the pressure buildup towards formation pressure. This process can be quite time-consuming, especially if the permeability is low and the build-up is slow. Obtaining pressure values for a series of depth points along a wellbore can be a tedious, slow, and sometimes hazardous process.

Accordingly, there is a desire in the art for a device and technique that would speed up the measurement process or even, ideally, provide a continuous, rather than a discreet, measurement.

It is among the objects of the present invention to overcome limitations of prior art apparatus and techniques for taking measurements, including formation pressure measurements, in a fluid-containing borehole having a mudcake thereon, and where supercharging may be occurring.

### SUMMARY OF THE INVENTION

An embodiment according to the invention can for example take advantage of the electrokinetic potential (EKP) generated by a flow of electrolyte between regions of different charge concentrations, induced by the presence of a pressure gradient. In particular, it is possible when the pressure gradient across the mudcake is zero, the formation pressure can be expected to be substantially equal to the borehole pressure.

In a formation that has a measurable permeability, loss of borehole fluid into the formation results in creation of a mudcake that limits significant further loss. A state of equilibrium is reached, which depends on the contrast between the formation and mudcake permeabilities. This state of equilibrium will almost always involve some small but finite residual flow across the mudcake, due to the large pressure gradient generated by the difference between the hydrostatic borehole pressure and the formation pressure. This finite flow will generate a measurable EKP. For any given conditions, the magnitude of the EKP should be approximately proportional to the flow rate, and thus the pressure difference across the mudcake.

In accordance with a form of the invention, a method is set forth for determining a property of formations surrounding a fluid-containing borehole having a mudcake on the surface thereof, including the following steps: providing a first electrode at the borehole side of the mudcake and a second electrode at the formation side of the mudcake; and measuring the electrokinetic potential between the first and second electrodes. An embodiment of this form of the invention can further include the following steps: modifying the borehole pressure; measuring the borehole pressure; and determining the true formation pressure using the measured borehole pressure and the measured electrokinetic potential. In this embodiment, the step of determining true formation pressure comprises determining the true formation pressure as being the borehole pressure when the electrokinetic potential is substantially zero.

In accordance with a further form of the invention, a method is set forth for determining true formation pressure in formations surrounding a fluid-containing borehole having a mudcake on the surface thereof, including the following steps: at a particular location in the borehole, monitoring the electrokinetic potential across the mudcake; modifying the borehole pressure at the particular location in the borehole; and determining the true formation pressure in the formations surrounding the particular location as being substantially the borehole pressure at which the electrokinetic potential is substantially zero. In an embodiment of this form of the invention, the step of monitoring the electrokinetic potential across the mudcake can comprise of providing a first electrode at the borehole side of the mudcake and a second electrode at the formation side of the mudcake, and measuring the electrokinetic potential between the first and second electrodes. The step of modifying the borehole pressure can comprise, for example, isolating a region of the borehole at the particular location, and modifying the borehole pressure in the region. Alternatively, the step of modifying the borehole pressure can comprise, for example, controlling the flow rate of fluid in the borehole. In an embodiment of this form of the invention, the step of determining the true formation pressure includes obtaining a measurement of borehole pressure at a time when the monitored electrokinetic potential is substantially zero. In another embodiment of this form of the invention, the step of determining the true formation pressure includes obtaining a plurality of measurement pairs of borehole pressure and electrokinetic potential, and extrapolating to determine what the borehole pressure would be when the electrokinetic potential is substantially zero.

Another form of the invention is directed to an apparatus for measuring a property of the mudcake on a fluid-containing borehole in earth formations, that includes: a logging device that is movable through the borehole; the logging device having first and second electrodes, the first electrode being positionable substantially adjacent to the mudcake on the borehole side thereof, and the second electrode being positionable to substantially penetrate the mudcake; and means for measuring the electrokinetic potential between the first and second electrodes. In an embodiment of this form of the invention, the means for measuring the electrokinetic potential between the first and second electrodes comprises a circuit for measuring electric potential. Also in an embodiment of this form of the invention, the second electrode is positionable substantially adjacent the mudcake on the formation side thereof, and the second electrode has a body that is at least partially insulated. The determined property of the mudcake can be a parameter representative of the pressure differential across the mudcake. In a disclosed embodiment, means are provided for controlling the borehole pressure in the region of the logging device, for example a pump-out module at the logging device, or a borehole fluid flow rate controller, which can be implemented from the surface of the earth. In this embodiment, a pressure metering circuit is associated with the logging device, to obtain the borehole pressure in the region of the logging device. A processor is provided for determining the true formation pressure using measurements of electrokinetic potential and borehole pressure.

Further features and advantages of the invention will become more readily apparent from the following detailed description when taken in conjunction with the accompanying drawings.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic diagram, partially in block form, of a well logging apparatus that can be used in practicing embodiments of the invention;

FIG. 2 is a diagram showing a logging device that is part of the FIG. 1 equipment, and which can be used in practicing embodiments of the invention;

FIG. 3 is a flow diagram that represents steps of a technique or routine, such as for controlling a processor, in accordance with an embodiment of the invention;

FIG. 4 is a schematic diagram, partially broken away, showing further details of an embodiment of the apparatus of FIGS. 1 and 2, and which can be used in practicing embodiments of the invention;

FIG. 5 is a schematic diagram, partially in block form, of a drilling apparatus and a logging while drilling system that can be used in practicing embodiments of the invention;

FIG. 6 is a diagram showing a logging device that is part of an embodiment of the FIG. 5 equipment, and which can be used in practicing embodiments of the invention.

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice. Further, like reference numbers and designations in the various drawings indicated like elements.

According to an embodiment according to the invention, the invention can take advantage of the electrokinetic potential (EKP) generated by a flow of electrolyte between regions of different charge concentrations, induced by the presence of a pressure gradient. For example, when the pressure gradient across the mudcake is zero, the formation pressure can be expected to be substantially equal to the borehole pressure. In particular, an embodiment according to the invention can include a method for determining a property of formations surrounding a fluid-containing borehole having a mudcake on the surface thereof. The method also includes providing a first electrode at the borehole side of the mudcake and a second electrode at the formation side of the mudcake. The method also includes measuring the electrokinetic potential between said first and second electrodes.

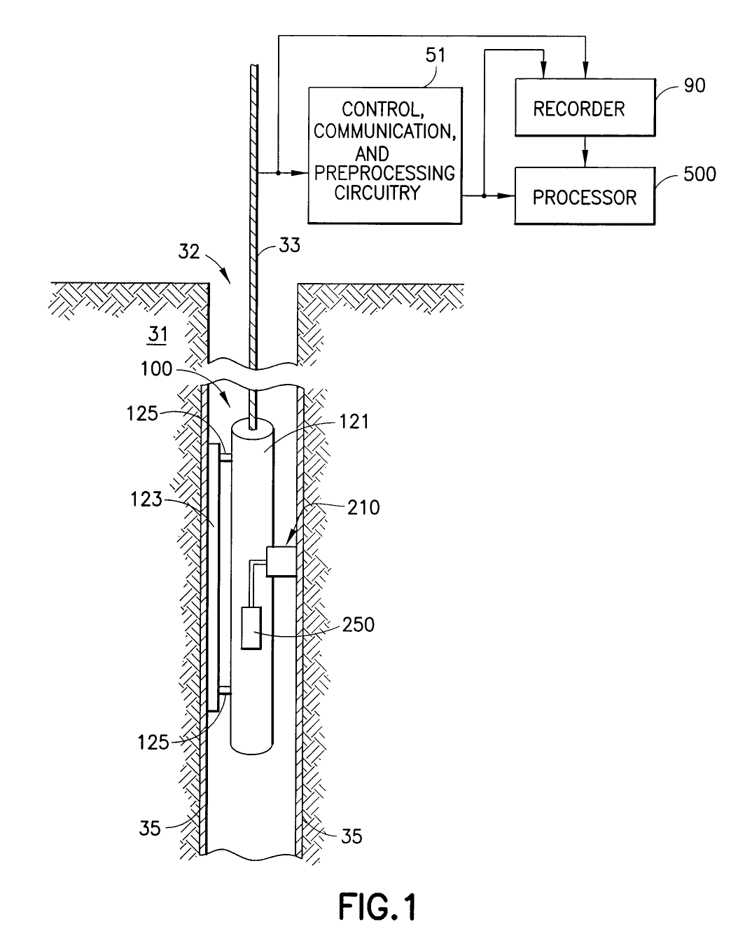

Referring to FIG. 1 there is shown a representative embodiment of an apparatus for investigating subsurface formations 31 traversed by a borehole 32, which can be used in practicing embodiments of the invention. The borehole 32 is typically filled with a drilling fluid or mud which contains finely divided solids in suspension. A mudcake on the borehole wall is represented at 35. The investigating apparatus or logging device 100 is suspended in the borehole 32 on an armored multiconductor cable 33, the length of which substantially determines the depth of the device 100. Known depth gauge apparatus (not shown) is provided to measure cable displacement over a sheave wheel (not shown) and thus the depth of the logging device 100 in the borehole 32. The cable length is controlled by suitable means at the surface such as a drum and winch mechanism (not shown). Circuitry 51, shown at the surface although portions thereof may typically be downhole, represents control, communication and preprocessing circuitry for the logging apparatus. This circuitry may be of known type. Further it is possible wireless type devices could be implemented for the logging apparatus. Uphole processor 500 and recorder 90 are also provided, as shown.

The logging device or tool 100 has an elongated body 121 which encloses the downhole portion of the device controls, chambers, measurement means, etc. Reference can be made, for example, to the above-mentioned U.S. Pat. Nos. 3,934,468 and 4,860,581, which describe devices of suitable general type. One or more arms 123 can be mounted on pistons 125 like devices which extend, e.g. under control from the surface, to set the tool. The logging device includes a module or pad 210 that is urged against the borehole wall, and described further herein below. The module 210 is shown as communicating with a block 250 that represents the subsystem of at least a downhole processor that can produce signals that can be communicated to the earth's surface.

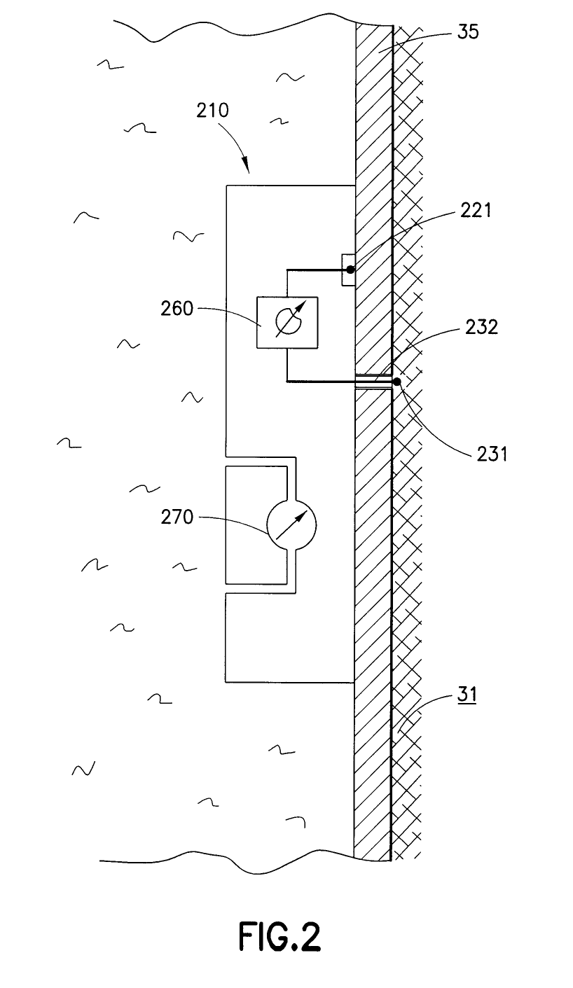

FIG. 2 shows the module 210 in further detail. A first electrode 221 is adjacent to or contiguous to the mudcake 35. A second electrode 231 is provided, and extends through the mudcake 35 into formations. The electrode 231 has insulation 232 thereon and can also have a protective coating or sheath (not separately shown) over the insulation. If desired, the second electrode 231 can be mechanically retractable. In the illustrated embodiment, the second electrode 231 can remain extended as the tool moves through the borehole. In such case, the shape of the probe sheath can optionally be provided with a blade-type edge to facilitate cutting through the mudcake. Also, it will be understood that the second electrode 231 may, in some cases, typically penetrate into an invaded zone of the formation and, in other cases, into the virgin formation. The electrodes 221, 231 are coupled, via insulated conductors, to electrical potential metering circuit 260 which, in the present embodiment, communicates with the downhole and/or uphole processors, which control the EKP monitoring operation. A pressure sensing circuit 270 is provided to obtain measurements of borehole pressure, and is also communicatively coupled with the downhole and/or uphole processors. In the embodiment of FIG. 2, the borehole pressure is varied, in any suitable way, for example, naturally or by controlling the mud flow rate from the surface.

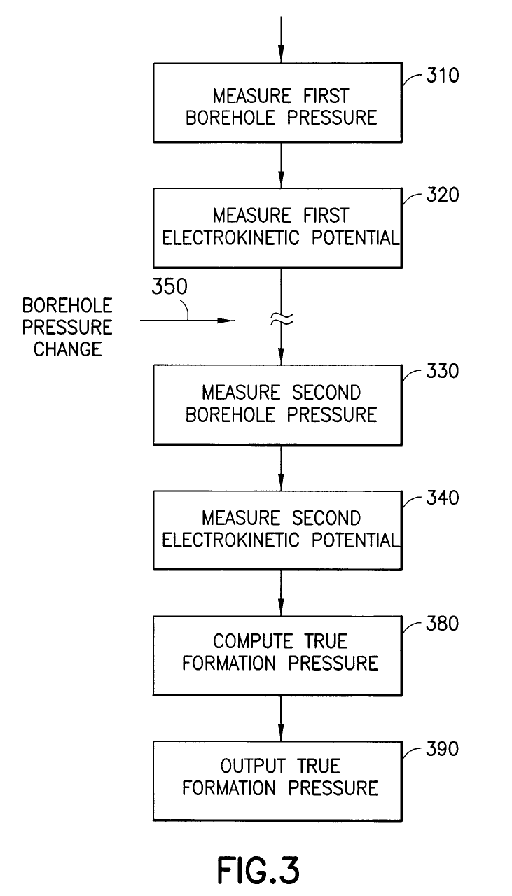

Referring to FIG. 3, there is shown a diagram of the steps that can be implemented in practicing an embodiment of the invention. The technique can be performed under processor control (from an uphole and/or downhole processor), or by a combination of processor control and uphole operator control. The block 310 represents measuring (and, in all cases, storing) of a first borehole pressure, and the block 320 represents the measuring of a first electrokinetic potential. Next, the arrow 350 represents the change in borehole pressure which, as noted above, can occur naturally in certain circumstances or can be achieved, for example, non-naturally by pumping on the well or by a technique of local pressure modification which will be described herein below. The block 330 represents measurement of the second borehole pressure, and the block 340 represents measurement of a second electrokinetic potential. Then, the block 380 represents determination of the true formation pressure using the measured pairs of borehole pressure and electrokinetic potential, for example by extrapolating a plot of borehole pressure versus electrokinetic potential to obtain the borehole pressure at which the electrokinetic potential would be substantially zero. This determined true formation pressure can then be read out, as represented by the block 390. It will be understood that further data pairs can be obtained and utilized. Also, it will be understood that, in some circumstances, the borehole pressure can be varied until the electrokinetic potential actually becomes zero, and that borehole pressure can then be deemed to be substantially the true formation pressure. It will be further understood that measurements can be taken periodically or continuously as the logging device is moved, to obtain values of true formation pressure as a function of depth level, and to form a log.

It will be understood that while a plurality of measurement pairs can be advantageously used in determining true formation pressure at a particular depth level, a single measurement pair of the electrokinetic potential and the borehole pressure can be used, for example in conjunction with empirically derived and/or physical model derived calibration, to determine true formation pressure.

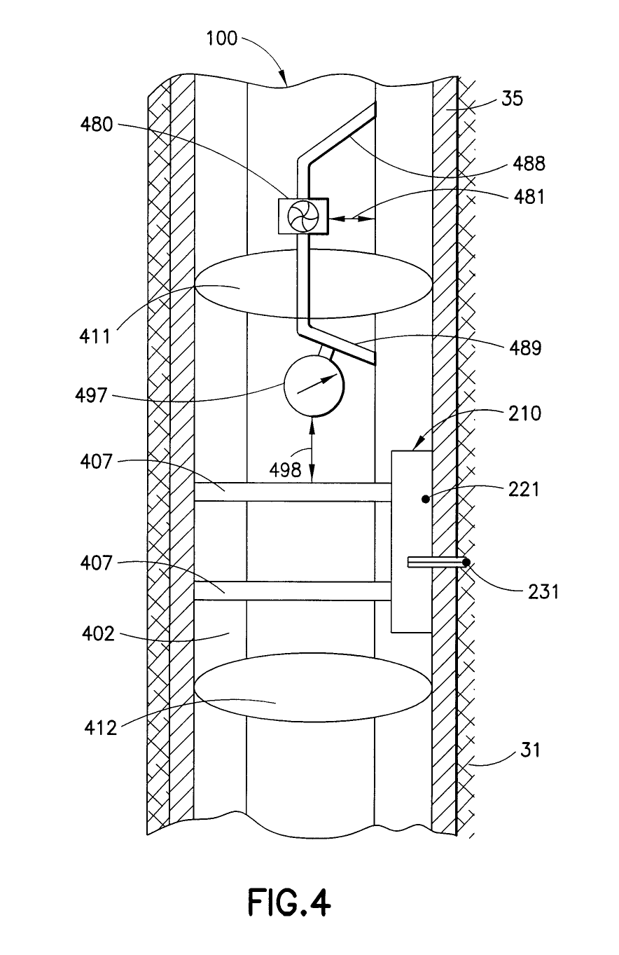

Referring to FIG. 4, there is shown another embodiment of a well logging device 100 that can be suspended in the borehole as in the embodiment of FIGS. 1 and 2, and which can be used to practice a form of the invention wherein the variation in borehole pressure is implemented by the logging device itself (which for purposes hereof includes any downhole equipment associated with the logging device) and is localized in the region where the device is positioned in the borehole at a given time. The device of FIG. 4 can include all the capabilities of the FIG. 2 logging device, and will have the indicated electrodes 221 and 231 and pressure sensing capabilities, etc., indicated by like reference numerals. The device 100 also includes inflatable packers 411 and 412, which can be of a type that is known in the art, together with suitable activation means (not separately shown). Reference can be made, for example, to U.S. Pat. No. 4,860,581 which describes operation of a packer used in conjunction with a logging device. When inflated, under control of the processors, the packers 411 and 412 isolate the region 402 of the borehole, and the module 210 of the logging device, shown with setting pistons 407 or the like, operates from within the isolated region 402. A pump-out module 480, which can be of a known type (see, for example, U.S. Pat. No. 4,860,581), includes a pump and a valve, and the pump-out module 480 communicates via a line 488 with the borehole outside the isolated region 402, and via a line 489, through the packer 411, with the isolated region 402 of the borehole, and serves to modify and control the pressure in the isolated region. The pump-out module 480 is under control of the processors, as represented by double-headed arrow 481. The borehole pressure in the isolated region is measured by pressure sensor circuit 497, which communicates with the processors, as represented by double-headed arrows 498.

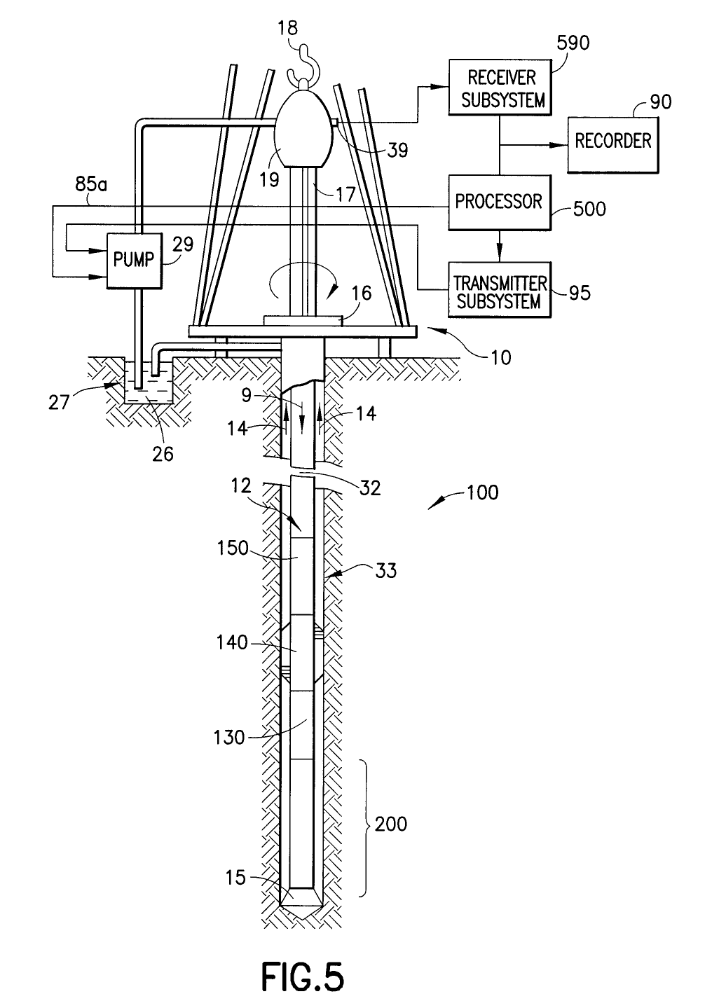

Referring to FIG. 5, there is illustrated a logging-while-drilling apparatus of a type which can be used in practicing embodiments of the invention. [As used herein, and unless otherwise specified, logging-while-drilling (sometimes called measuring-while-drilling) is intended to include the taking of measurements in an earth borehole, with the drill bit and at least some of the drill string in the borehole, during drilling, pausing, and/or tripping.] A platform and derrick 10 are positioned over a borehole 33 that is formed in the earth by rotary drilling. A drill string 12 is suspended within the borehole and includes a drill bit 15 at its lower end. The drill string 12 and the drill bit 15 attached thereto are rotated by a rotating table 16 (energized by means not shown) which engages a kelly 17 at the upper end of the drill string. The drill string is suspended from a hook 18 attached to a traveling block (not shown). The kelly 17 is connected to the hook 18 through a rotary swivel 19 which permits rotation of the drill string 12 relative to the hook 18. Alternatively, for example, the drill string 12 and drill bit 15 may be rotated from the surface by a “top drive” type of drilling rig. Drilling fluid or mud 26 is contained in a pit 27 in the earth. A controllable pump 29 pumps the drilling mud 26 into the drill string 12 via a port in the swivel 19 to flow downward (arrow 9) through the center of drill string 12. The drilling mud 26 exits the drill string 12 via ports in the drill bit 15 and then circulates upward in the region between the outside of the drill string 12 and the periphery of the borehole 33, commonly referred to as the annulus, as indicated by the flow arrows 14. The drilling mud 26 thereby lubricates the bit 15 and carries formation cuttings to the surface of the earth. The drilling mud 26 is returned to the pit 27 for recirculation after suitable conditioning. An optional directional drilling assembly (not shown) with a mud motor having a bent housing or an offset sub could also be employed. A roto-steerable system (not shown) could also be used.

Mounted within the drill string 12, preferably near the drill bit 15, is a bottom hole assembly, generally referred to by reference numeral 100, which includes capabilities for measuring, for processing, and for storing information, and for communicating with the earth's surface. [As used herein, “near the drill bit” means within several drill collar lengths from the drill bit.] The assembly 100 includes a measuring and local communications apparatus 200, parts of which are described further herein below. In the example of the illustrated bottom hole arrangement, a drill collar 130 and a stabilizer collar 140 are shown successively above the apparatus 200. The collar 130 may be, for example, a pony collar or a collar housing measuring apparatus.

Located above stabilizer collar 140 is a surface/local communications subassembly 150. The subassembly 150 can include any suitable type of wired and/or wireless downhole communication system. Known types of equipment include a toroidal antenna or electromagnetic propagation techniques for local communication with the apparatus 200 (which also has similar means for local communication) and also an acoustic communication system that communicates with a similar system at the earth's surface via signals carried in the drilling mud. Alternative techniques for communication with the surface, for example wired drillpipe, can also be employed. The surface communication system in subassembly 150 includes an acoustic transmitter which generates an acoustic signal in the drilling fluid that is typically representative of measured downhole parameters. One suitable type of acoustic transmitter employs a device known as a “mud siren” which includes a slotted stator and a slotted rotor that rotates and repeatedly interrupts the flow of drilling mud to establish a desired acoustic wave signal in the drilling mud. The driving electronics in subassembly 150 may include a suitable modulator, such as a phase shift keying (PSK) modulator, which conventionally produces driving signals for application to the mud transmitter. These driving signals can be used to apply appropriate modulation to the mud siren. The generated acoustic mud wave travels upward in the fluid through the center of the drill string at the speed of sound in the fluid. The acoustic wave is received at the surface of the earth by transducers represented by reference numeral 39. The transducers, which are, for example, piezoelectric transducers, convert the received acoustic signals to electronic signals. The output of the transducers 39 is coupled to the uphole receiving subsystem 590 which is operative to demodulate the transmitted signals, which can then be coupled to processor 500 and recorder 90 which, inter alia, can produce recorded logs. An uphole transmitting subsystem 95 is also provided, and can control interruption of the operation of pump 29 in a manner which is detectable by the transducers in the subassembly 150, so that there is two way communication between the subassembly 150 and the uphole equipment. The subsystem 150 may also conventionally include acquisition and processor electronics comprising a microprocessor system (with associated memory, clock and timing circuitry, and interface circuitry) capable of storing data from a measuring apparatus, processing the data and storing the results, and coupling any desired portion of the information it contains to the transmitter control and driving electronics for transmission to the surface. A battery may provide downhole power for this subassembly. As known in the art, a downhole generator (not shown) such as a so-called “mud turbine” powered by the drilling mud, can also be utilized to provide power, for immediate use or battery recharging, during drilling. As above noted, alternative techniques can be employed for communication with the surface of the earth. Also, while it is preferred to obtain the true formation pressure information in substantially real time, it will be understood that the measurements can alternatively be stored downhole and recovered when the logging device is brought to the earth's surface.

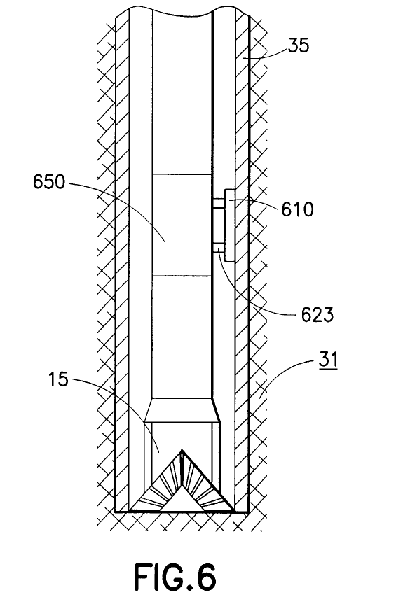

In an embodiment hereof, the logging device, which can have a structure similar to that of FIG. 2 or FIG. 4, adapted for measuring while drilling application, is part of the measuring and local communications apparatus 200 (of FIG. 2). As shown in FIG. 6, one or more arms 623 can be mounted on pistons which extend, e.g. under control of the processors and/or from the surface, to set the tool. The logging device includes module 610, similar to module 210 of FIG. 2 that is outwardly displaced into contact with the borehole wall 35. The module 610 includes the electrodes for measuring electrokinetic potential and the pressure sensor, as previously described. The module 610 communicates with a block 650 that represents the subsystem circuitry and downhole processor, as previously described, for determining, inter alia, true formation pressure and producing electrical signals representative thereof that can be communicated to the earth's surface.

The invention has been described with reference to particular preferred embodiments, but variations within the spirit and scope of the invention will occur to those skilled in the art. For example, it will be understood that the tool arrangements can be in other suitable configurations that make the same or similar measurements. Further, it is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A method for determining a property of formations surrounding a fluid-containing borehole having a mudcake on the surface thereof, comprising the steps of:
providing a first electrode at the borehole side of the mudcake and a second electrode at the formation side of the mudcake; and
measuring the electrokinetic potential between said first and second electrodes.

2. The method as defined by claim 1, further comprising the steps of:
modifying the borehole pressure;
measuring the borehole pressure; and
determining the true formation pressure using the measured borehole pressure and the measured electrokinetic potential.

3. The method as defined by claim 2, wherein said step of determining true formation pressure comprises determining said true formation pressure as being the borehole pressure when said electrokinetic potential is substantially zero.

4. A method for determining true formation pressure in formations surrounding a fluid-containing borehole having a mudcake on the surface thereof, comprising the steps of:
at a particular location in the borehole, monitoring the electrokinetic potential across the mudcake;
modifying the borehole pressure at the particular location in the borehole; and
determining the true formation pressure in the formations surrounding said particular location as being substantially the borehole pressure at which said electrokinetic potential is substantially zero.

5. The method as defined by claim 4, wherein said step of monitoring the electrokinetic potential across the mudcake comprises providing a first electrode at the borehole side of the mudcake and a second electrode at the formation side of the mudcake, and measuring the electrokinetic potential between said first and second electrodes.

6. The method as defined by claim 4, wherein said step of modifying the borehole pressure comprises isolating a region of the borehole at the particular location, and modifying the borehole pressure in said region.

7. The method as defined by claim 4, wherein said step of modifying the borehole pressure comprises controlling the flow rate of fluid in the borehole.

8. The method as defined by claim 4, wherein said step of determining the true formation pressure includes obtaining a measurement of borehole pressure at a time when the monitored electrokinetic potential is substantially zero.

9. The method as defined by claim 4, wherein said step of determining the true formation pressure includes obtaining a plurality of measurement pairs of borehole pressure and electrokinetic potential, and extrapolating to determine what the borehole pressure would be when the electrokinetic potential is substantially zero.

10. The method as defined by claim 4, further comprising repeating the method at a number of different depth levels in the borehole to obtain a number of determinations of true formation pressure, and forming a log of true formation pressure as a function of depth level.

11. A method for determining true formation pressure in formations surrounding a fluid-containing borehole having a mudcake on the surface thereof, comprising the steps of:
modifying the pressure in the borehole;
at a particular location in the borehole, determining a plurality of measurement pairs of borehole pressure and electrokinetic potential across the mudcake; and
determining the true formation pressure at the particular location in the borehole, using said measurement pairs.

12. The method as defined by claim 11, wherein said step of determining the true formation pressure comprises determining, from said plurality of measurement pairs, the borehole pressure when said electrokinetic potential is substantially zero.

13. The method as defined by claim 11, wherein said step of determining said plurality of measurement pairs includes measuring electrokinetic potential across the mudcake by providing a first electrode at the borehole side of the mudcake and a second electrode at the formation side of the mudcake, and measuring the electrokinetic potential between said first and second electrodes.

14. The method as defined by claim 13, further comprising moving said electrodes longitudinally along the mudcake and taking substantially continuous measurements of electrokinetic potential.

15. Apparatus for measuring a property of the mudcake on a fluid-containing borehole in earth formations comprising:
a logging device that is movable through the borehole;
said logging device having first and second electrodes, said first electrode being positionable substantially adjacent to the mudcake on the borehole side thereof, and said second electrode being positionable to substantially penetrate the mudcake; and
means for measuring the electrokinetic potential between said first and second electrodes.

16. Apparatus as defined by claim 15, wherein said means for measuring the electrokinetic potential between said first and second electrodes comprises a circuit for measuring electric potential.

17. Apparatus as defined by claim 15, wherein said second electrode is positionable substantially adjacent the mudcake on the formation side thereof.

18. Apparatus as defined by claim 15, wherein said second electrode has a body that is at least partially insulated.

19. Apparatus as defined by claim 15, wherein said property of the mudcake is a parameter representative of the pressure differential across the mudcake.

20. Apparatus as defined by claim 15, further comprising means for controlling the borehole pressure in the region of the logging device.

21. Apparatus as defined by claim 20, wherein said means for controlling the borehole pressure in the region of the logging device comprises a pump-out module.

22. Apparatus as defined by claim 20, wherein said means for controlling the borehole pressure in the region of the logging device comprises a borehole fluid flow rate controller.

23. Apparatus as defined by claim 15, further comprising a pressure metering circuit associated with said logging device, to obtain the borehole pressure in the region of the logging device.

24. Apparatus as defined by claim 20, further comprising a pressure metering circuit associated with said logging device, to obtain the borehole pressure in the region of the logging device.

25. Apparatus as defined by claim 24, further comprising a processor for determining the true formation pressure using measurements of electrokinetic potential and borehole pressure.

26. Apparatus as defined by claim 15, wherein said logging device is suspended on a wireline.

27. Apparatus as defined by claim 15, wherein said logging device is a measuring while drilling device on a drill string.
